(19) United States
(12) Patent Application Publication
(10) Pub. No.: US 2018/0170234 A1
(43) Pub. Date: Jun. 21, 2018

(54) ROLL-OFF FRAME HAVING ADJUSTABLE HEAD AND TAIL PORTIONS ACTUATED BY SINGLE ACTUATION STROKE

(71) Applicant: Omaha Standard, LLC, Council Bluffs, IA (US)

(72) Inventors: Lazar MARMUR, Plainsboro, NJ (US); Kenneth E. BAILEY, JR., Vineland, NJ (US); Wayne Harry DAVIS, Lumberton, NJ (US)

(21) Appl. No.: 15/383,541

(22) Filed: Dec. 19, 2016

(51) Int. Cl. B60P 1/64

(52) U.S. Cl. CPC B60P 1/6454; B60P 1/6409

(57) ABSTRACT

A hoisting frame apparatus for loading and unloading containers onto and off of a roll-off vehicle includes adjustable head and tail portions that are cooperatively actuated by a single actuation stroke to move relative to a main portion of the hoisting frame apparatus. The hoisting frame apparatus includes a linkage connecting the tail portion to the head portion such that displacement of the head portion by a hoist actuator relative to the main portion causes displacement of the tail portion relative to the main portion. The total longitudinal displacement of the tail portion may be shorter than the total longitudinal displacement of the head portion, and the linkage may be configured to release the connection between the head and tail portions when the tail portion reaches a travel limit to allow independent further longitudinal displacement of the head portion.

### FIELD OF THE INVENTION

The present invention relates generally to roll-off transport vehicles equipped to load a large container onto the vehicle and to unload the container from the vehicle. The large container is typically a waste container.

### BACKGROUND OF THE INVENTION

Roll-off vehicles are known to include a top frame mounted on the vehicle for supporting the container. The top frame is pivotally mounted to be tilted away from a horizontal home position such that the top frame is inclined toward a rear of the vehicle to assist in loading and unloading the container. The top frame may be tilted by one or more lift actuators, for example hydraulically powered linear actuators, arranged between the top frame and a subframe fixed to the vehicle. The top frame may incorporate a cable hoist mechanism having a set of sheaves and a cable wound around the sheaves. Some of the sheaves may be mounted on one or more movable shoe members that are displaceable along the top frame to take up an end of the cable coupled to the container to pull the container onto the top frame during loading. Sheave displacement may be reversed to unload the container. A locking mechanism may be provided at the front of the frame for engaging a front roller or grip bar of the container to secure the container on the frame during transport.

Roll-off frames of the type described above may include an extendable and retractable tail portion designed to extend from a main portion of the frame when the frame is tilted to meet the ground proximate to the rear of the vehicle. For example, U.S. Pat. No. 6,641,353 describes a roll-off frame 10 that has an extendable tail portion 18 operated by a hydraulic actuator 44. As another example, U.S. Pat. No. 8,708,635 discloses a roll-off frame wherein a hydraulic cylinder 410 extends a tail portion 402 relative to a main portion 404 of the frame to reach the ground. As a further example, U.S. Pat. No. 8,746,804 describes a tiltable frame 104 having a sliding tail portion 108 moved by actuators 160.

It is also known to provide a roll-off frame with an extendable and retractable head portion for adjustably accommodating containers of various lengths. U.S. Pat. No. 7,112,030 discloses a roll-off frame having a main portion 14 and an extendable head portion 26 moved by a pair of hydraulic actuators 50.

In the prior art roll-off frames summarized above, there is either an extendable and retractable tail portion, or an extendable and retractable head portion, but not both. The actuators used to move the tail or head portion are dedicated to that function, and are not used for any other function.

U.S. Pat. No. 4,840,532 describes a roll-off frame having both a tail portion 72 and a head portion 75 respectively extendable and retractable relative to a main frame portion. The tail portion 72 is operated by a dedicated actuator 74; the head portion 75 is operated independently by a separate dedicated actuator 81. The use of separate and independently operable actuators for driving the tail and head portions adds weight and expense. Moreover, where the actuators are hydraulic actuators, the hydraulic system becomes more complex.

### SUMMARY OF THE INVENTION

The invention provides a hoisting frame apparatus for loading and unloading containers onto and off of a roll-off vehicle. The invention addresses shortcomings of the prior art by providing adjustable head and tail portions that are cooperatively actuated by a single actuation stroke.

The apparatus comprises a top frame including a main portion, a head portion movably connected to the main portion for longitudinally directed displacement relative to the main portion between a rearward retracted position and forward extended position, and a tail portion movably connected to the main portion for longitudinally directed displacement relative to the main portion between a rearward extended position and forward retracted position. The apparatus also comprises a plurality of sheaves including a rear sheave mounted to the main portion and a front sheave mounted to the head portion, and a cable having a fixed end coupled to the head portion and a free end configured for coupling to a container, wherein the cable extends from the fixed end to the free end by way of the sheaves. The apparatus further comprises a hoist actuator operable to longitudinally displace the head portion of the top frame relative to the main portion of the top frame between the rearward retracted position and the forward extended position, and a linkage connecting the tail portion of the top frame to the head portion of the top frame, wherein displacement of the head portion by the hoist actuator relative to the main portion causes displacement of the tail portion relative to the main portion. The linkage may be bidirectional, whereby displacement of the head portion by the hoist actuator from the rearward retracted position to the forward extended position causes displacement of the tail portion from the rearward extended position to the forward retracted position, and displacement of the head portion by the hoist actuator from the forward extended position to the rearward retracted position causes displacement of the tail portion from the forward retracted position to the rearward extended position.

In an embodiment of the invention, a longitudinal displacement distance of the head portion between the rearward retracted position and the forward extended position is greater than a longitudinal displacement distance of the tail portion between the rearward extended position and the forward retracted position. The apparatus may further comprise a forward limit stop preventing the tail portion from traveling forward relative to the main portion beyond the forward retracted position, and a rearward limit stop preventing the tail portion from traveling rearward relative to the main portion beyond the rearward extended position, and the linkage may be configured to couple the head portion and the tail portion together for displacement in unison when the tail portion is between the limit stops, and configured to decouple the head portion from the tail portion for independent displacement of the head portion relative to the main portion when the tail portion is at one of the limit stops.

The linkage may include a connection rod fixed to one of the head portion and the tail portion, wherein the connection rod has an engagement segment, and the linkage may further include a detent mechanism fixed to the other of the head portion and the tail portion, wherein the connection rod is slidably received by the detent mechanism. The detent mechanism may be biased for releasable engagement with the engagement segment of the connection rod to releasably couple the head portion and the tail portion together. For example, the engagement segment of the connection rod may include at least one recess, and the detent mechanism may include at least one ball plunger spring-biased for receipt by the at least one recess. The connection rod may also include a first slide segment and a second slide segment, and the engagement segment may be located between the first and second slide segments.

The invention provides longitudinal displacements of both the head and tail portions relative to the main portion of the top frame using a single actuation stroke, even where the displacement distance of the head portion differs from the displacement distance of the tail portion. Consequently, only a single actuator is required to drive both displacements, thereby reducing cost and complexity, especially if an additional hydraulic actuator is avoided.

### BRIEF DESCRIPTION OF THE DRAWING VIEWS

The nature and mode of operation of the present invention will now be more fully described in the following detailed description of the invention taken with the accompanying drawing figures, in which:

FIG. 1 is a perspective view of a roll-off vehicle equipped with a container hoist apparatus formed in accordance with the present invention and onto which a container has been loaded;

FIG. 2 is a perspective view showing the container hoist apparatus of FIG. 1;

FIG. 3 is an exploded perspective view of the container hoist apparatus, wherein a hoist cable of the apparatus is removed for sake of clarity;

FIG. 4 is an exploded perspective view of a portion of the container hoist apparatus illustrating an arrangement of the hoist cable and associated sheaves of the apparatus;

FIG. 5 is a perspective view of a portion of the container hoist apparatus, partially sectioned to reveal a linkage of the apparatus;

FIG. 6 is partially sectioned elevational view showing the linkage revealed in FIG. 5;

FIG. 7 is a cross-sectional view taken generally about the line 7-7 in FIG. 5, illustrating a detent mechanism of the linkage;

FIG. 8 is a side elevational view of a roll-off vehicle equipped with the container hoist apparatus and loaded with a container;

FIG. 9 is an isolated plan view of a top frame of the container hoist apparatus corresponding to the loaded condition shown in FIG. 8;

FIG. 10 is a side elevational view of the top frame shown in FIG. 9;

FIG. 11 is a detailed view, partially sectioned, showing a linkage of the top frame depicted in FIG. 10;

FIG. 12 is a side elevational view of the roll-off vehicle shown in FIG. 8, showing a first step in a process of unloading the container;

FIG. 13 is an isolated plan view of the top frame of the container hoist apparatus corresponding to the first step shown in FIG. 12;

FIG. 14 is a side elevational view of the top frame shown in FIG. 13;

FIG. 15 is a detailed view, partially sectioned, showing the linkage of the top frame depicted in FIG. 14;

FIG. 16 is a side elevational view of the roll-off vehicle shown in FIG. 8, showing a second step in a process of unloading the container;

FIG. 17 is an isolated plan view of the top frame of the container hoist apparatus corresponding to the second step shown in FIG. 16;

FIG. 18 is a side elevational view of the top frame shown in FIG. 17;

FIG. 19 is a detailed view, partially sectioned, showing the linkage of the top frame depicted in FIG. 18;

FIG. 20 is a cross-sectional view of a detent mechanism of the linkage shown in FIG. 19;

FIG. 21 is a side elevational view of the roll-off vehicle shown in FIG. 8, showing a third step in a process of unloading the container;

FIG. 22 is an isolated plan view of the top frame of the container hoist apparatus corresponding to the third step shown in FIG. 21;

FIG. 23 is a side elevational view of the top frame shown in FIG. 22;

FIG. 24 is a detailed view, partially sectioned, showing the linkage of the top frame depicted in FIG. 23;

FIG. 25 is a side elevational view of the roll-off vehicle shown in FIG. 8, showing a fourth step in a process of unloading the container;

FIG. 26 is an isolated plan view of the top frame of the container hoist apparatus corresponding to the fourth step shown in FIG. 25;

FIG. 27 is a side elevational view of the top frame shown in FIG. 26;

FIG. 28 is a detailed view, partially sectioned, showing the linkage of the top frame depicted in FIG. 27;

FIG. 29 is a side elevational view of the roll-off vehicle shown in FIG. 8, showing a fifth and final step in a process of unloading the container;

FIG. 30 is an isolated plan view of the top frame of the container hoist apparatus corresponding to the fifth step shown in FIG. 29;

FIG. 31 is a side elevational view of the top frame shown in FIG. 30; and

FIG. 32 is a detailed view, partially sectioned, showing the linkage of the top frame depicted in FIG. 31.

### DETAILED DESCRIPTION OF THE INVENTION

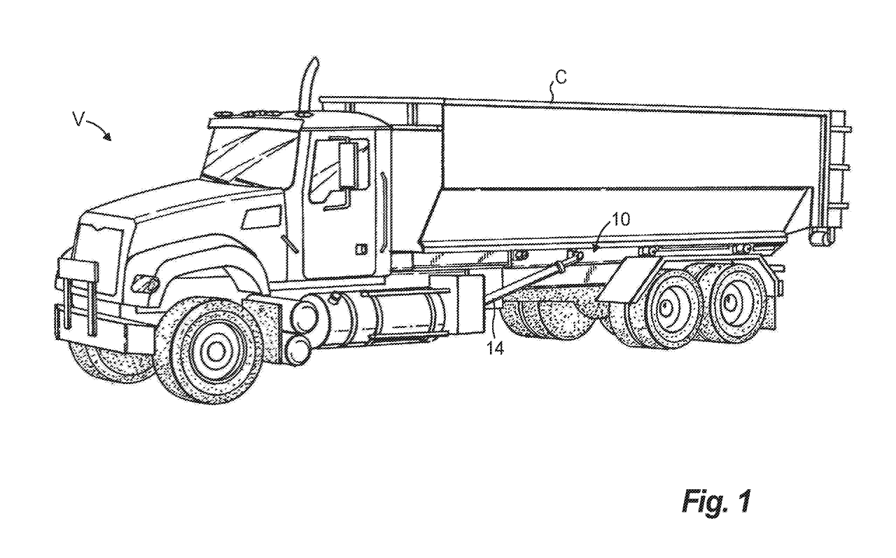

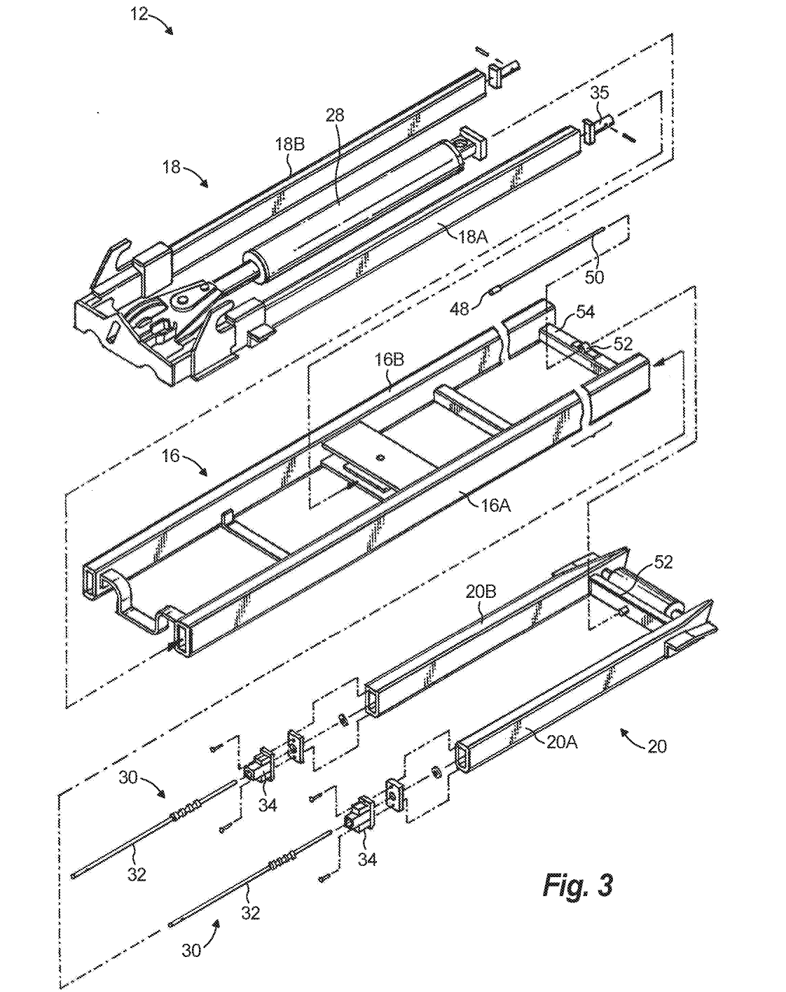

FIGS. 1-7 illustrate a container hoist apparatus 10 formed in accordance with an embodiment of the present invention. Hoist apparatus 10 is mountable on a roll-off vehicle V, such as a truck or similar vehicle, and includes a cable hoist mechanism connectable to a container C. As will be apparent from the detailed description that follows, apparatus 10 is useful for loading and unloading containers of various sizes onto and off of a roll-off vehicle in a safe and efficient manner. In FIGS. 1-7, the forward direction is generally to the left and the rearward direction is generally to the right.

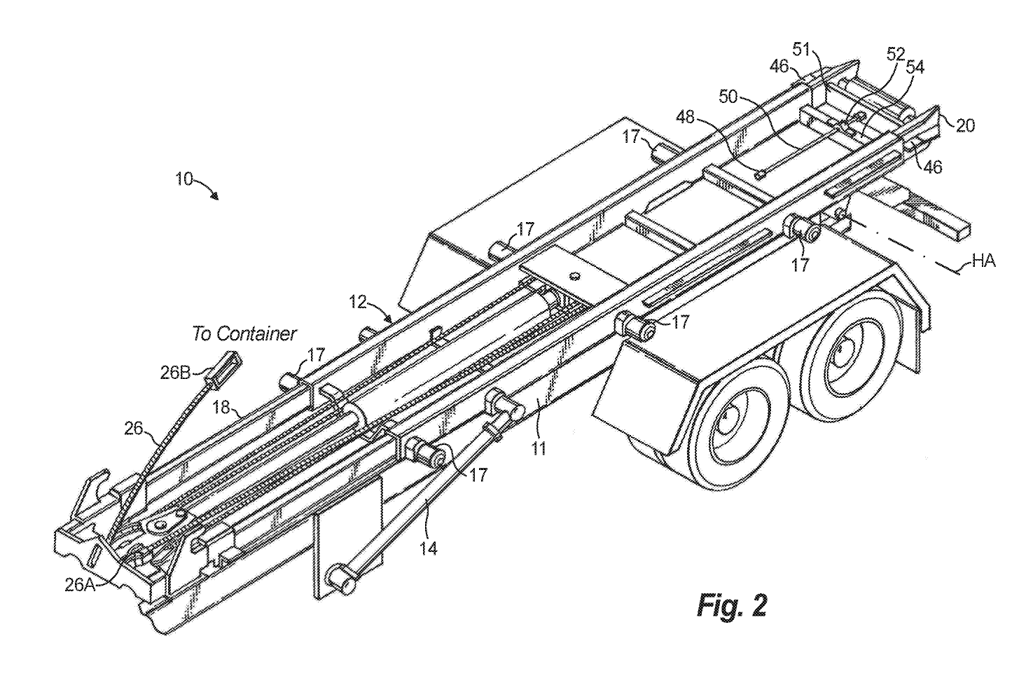

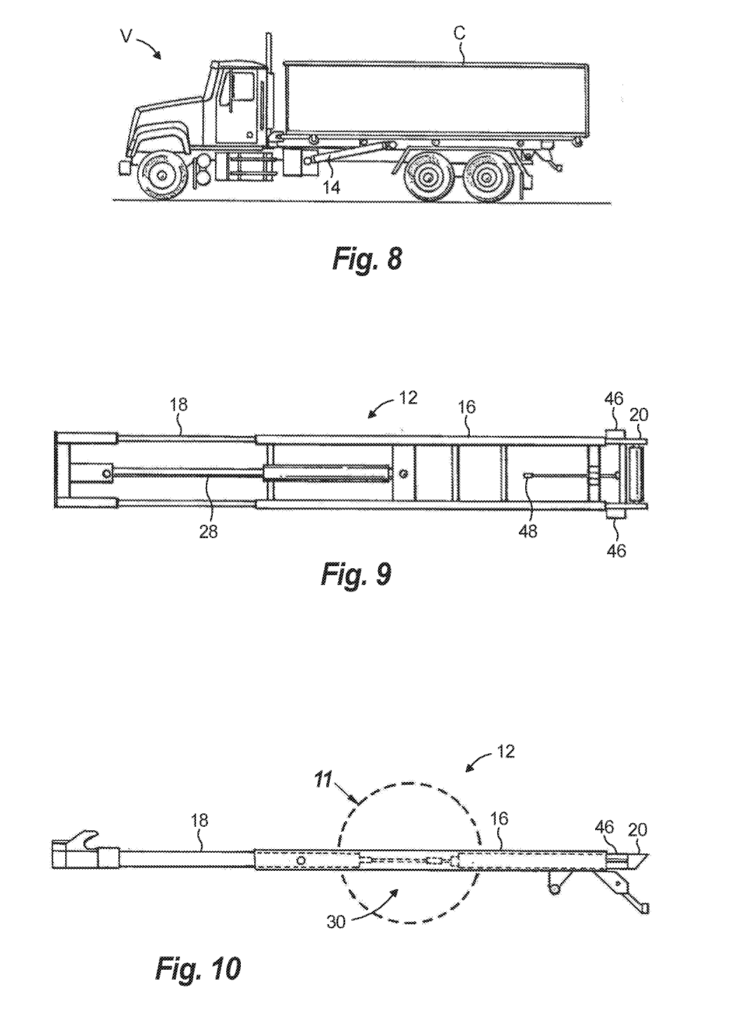

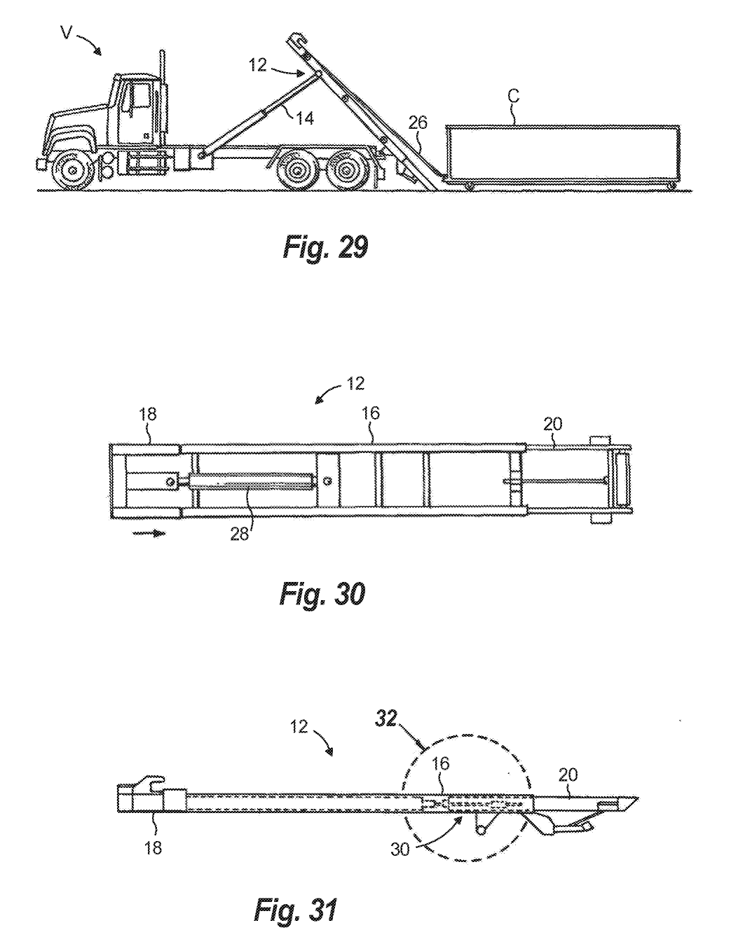

Apparatus 10 generally comprises a top frame 12 and a pair of laterally spaced lift actuators 14, only one of the lift actuators being visible in FIGS. 1 and 2. Top frame 12 is mounted on vehicle V to pivot about a transverse hinge axis HA relative to the vehicle. For example, apparatus 10 may comprise a subframe 11 adapted to be fixedly attached to the vehicle V, and top frame 12 may be pivotally mounted on subframe 11 for pivoting motion about hinge axis HA. In this way, top frame 12 may be mounted on vehicle V by way of subframe 11. As shown in FIGS. 1 and 8, top frame 12 has a horizontal home position relative to vehicle V. One end of each lift actuator 14 is pivotally mounted to vehicle V either directly or indirectly through subframe 11. The opposite end of each lift actuator 14 is pivotally mounted to top frame 12. Lift actuators 14 are operable to rearwardly incline top frame 12 relative to vehicle V by pivoting the top frame about hinge axis HA away from the horizontal home position. For example, lift actuators 14 may be extended to tilt top frame 12 as shown in FIG. 29, and may be retracted such that top frame 12 assumes its horizontal home position as shown in FIGS. 1 and 8. Lift actuators 14 may be hydraulic actuators. Alternatively, lift actuators 14 may be electromechanical actuators. While two laterally spaced lift actuators 14 may be used, it is conceivable to practice the invention using only one lift actuator which may be centrally located for balanced loading.

Top frame 12 includes a main portion 16, a head portion 18, and a tail portion 20. Head portion 18 is movably connected to main portion 16 for longitudinally directed displacement relative to the main portion between a rearward retracted position and forward extended position. For example, main portion 16 and head portion 18 may be telescopically adjustable, wherein a pair of longitudinal side rails 18A, 18B of head portion 18 are slidably received within hollow longitudinal side rails 16A, 16B of main portion 16. Tail portion 20 is movably connected to main portion 16 for longitudinally directed displacement relative to the main portion between a rearward extended position and forward retracted position. Main portion 16 and tail portion 20 may be telescopically adjustable, wherein a pair of longitudinal side rails 20A, 20B of tail portion 20 are slidably received within hollow longitudinal side rails 16A, 16B of main portion 16.

Main portion 16, head portion 18, and tail portion 20 may be steel weldments. In the depicted embodiment, side rails 16A, 16B include a plurality of support rollers 17 for supporting opposite sides of container C as the container is displaced along top frame 12.

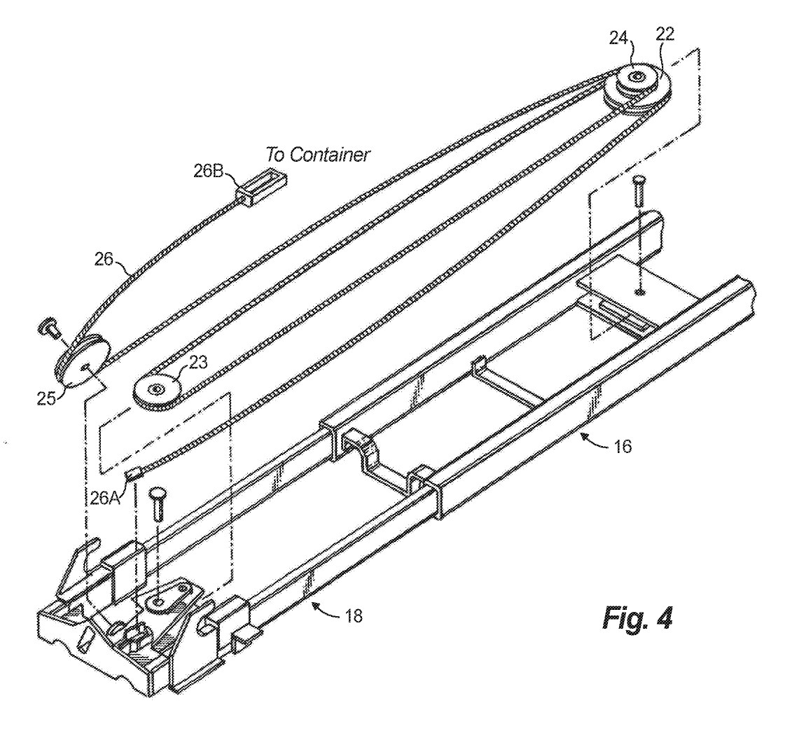

Top frame 12 also includes a plurality of sheaves including a rear sheave 22 mounted to main portion 16 and a front sheave 25 mounted to head portion 18. As best seen in FIG. 4, the plurality of sheaves may further include a first intermediate sheave 23 mounted to head portion 18 and a second intermediate sheave 24 mounted to main portion 16. Rear sheave 22 and second intermediate sheave 24 may be coaxial as shown in FIG. 4.

A hoist cable 26 has a fixed end 26A coupled to head portion 18 and a free end 26B configured for coupling to a container C. Cable 26 extends from its fixed end 26A to its free end 26B by way of the plurality of sheaves. For example, in the illustrative arrangement depicted in FIG. 4, cable 26 extends from fixed end 26A to free end 26B by successive engagement with rear sheave 22, first intermediate sheave 23, second intermediate sheave 24, and front sheave 25.

Top frame 12 further includes a hoist actuator 28 operable to longitudinally displace head portion 18 relative to main portion 16 between a rearward retracted position shown in FIG. 30 and a forward extended position shown in FIGS. 2 and 9. As may be understood, displacement of head portion 18 toward the extended position moves first intermediate sheave 23 and front sheave 25 away from rear sheave 22 and second intermediate sheave 24, thereby causing free end 26B of cable 26 to be pulled forward toward the front end of top frame 12. The diameters of the sheaves may be chosen to provide a mechanical advantage such that displacement of head portion 18 by hoist actuator 28 through a given distance results in an even greater displacement of cable end 26B toward the front end of top frame 12. For example, the sheaves may be sized and arranged to provide a 5:1 mechanical advantage, i.e. extending head portion 18 one foot draws cable end 26B five feet forward.

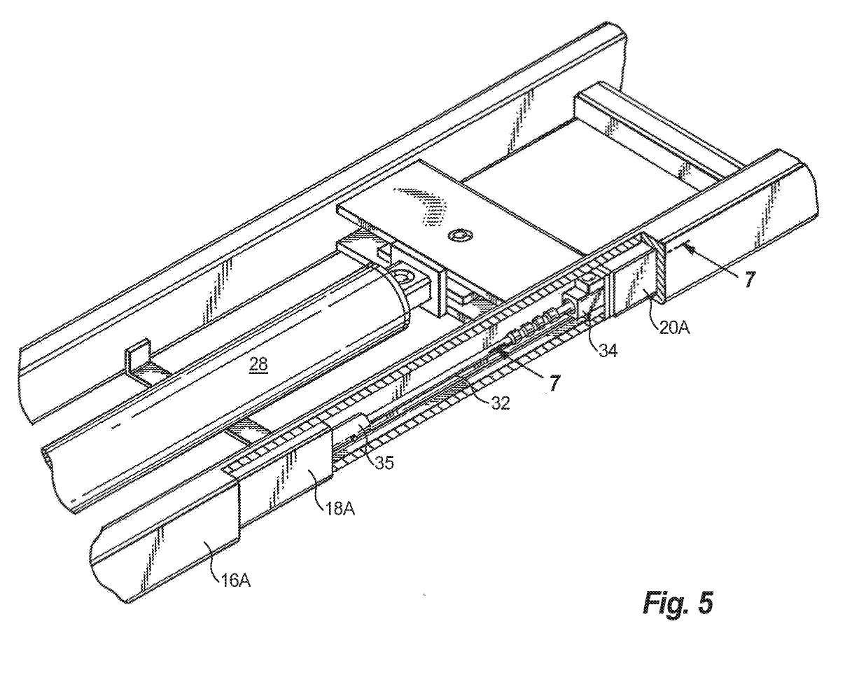

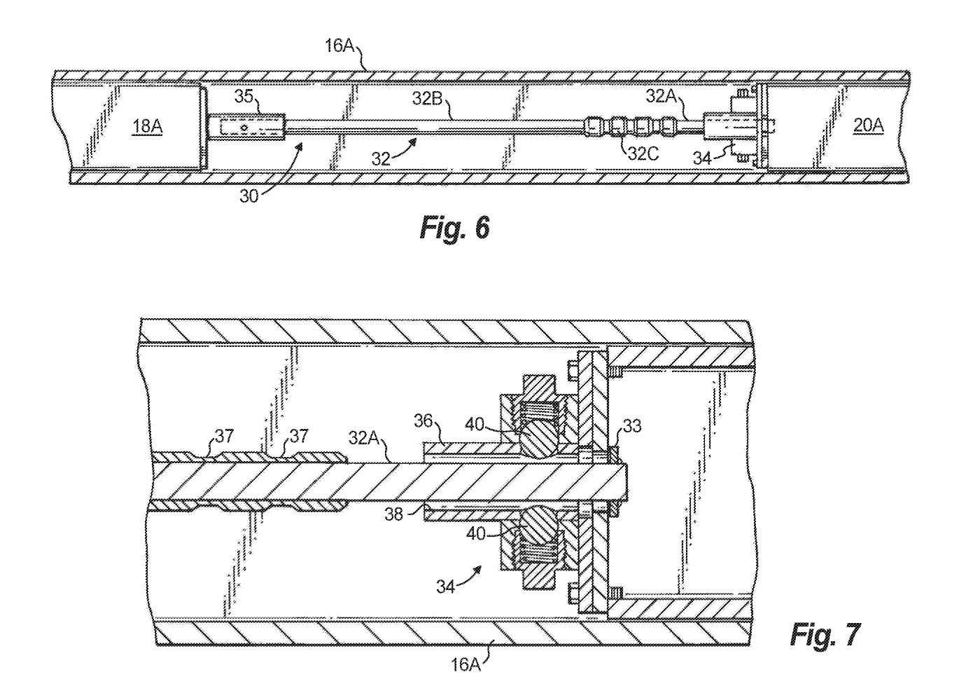

In accordance with the present invention, tail portion 20 of top frame 12 is connected to head portion 18 by at least one linkage 30, such that displacement of the head portion by hoist actuator 28 relative to main portion 16 causes displacement of tail portion 20 relative to main portion 16. In the embodiment described herein, a pair of linkages 30 are provided, one on each lateral side of frame 12, however only one of the linkages is visible in FIGS. 5 and 6. Each linkage 30 may include a connection rod 32 cooperating with a detent mechanism 34 as described in detail below. In the embodiment depicted in the figures, connection rod 32 is fixed to head portion 18, and detent mechanism 34 is fixed to tail portion 20. More specifically, a front end of connection rod 32 may be fixedly attached to a rear end of a respective longitudinal side rail 18A of head portion 18 by a mounting collar 35 welded or fastened to side rail 18A, and detent mechanism 34 may be welded or fastened to a front end of a respective longitudinal side rail 20A of tail portion 20, wherein connection rod 32 is slidably received by associated detent mechanism 34. One skilled in the art will understand that the arrangement of connection rod 32 and detent mechanism is 34 may be reversed, i.e. detent mechanism 34 may be fixed to head portion 18 and connection rod 32 may be fixed to tail portion 20.

In the present embodiment, connection rod 32 includes a first slide segment 32A and a second slide segment 32B separated by an engagement segment 32C. Connection rod 32 may also include a retention flange 33 at its free end. Detent mechanism 34 is configured to allow first and second slide segments 32A, 32B to slide through detent mechanism 34 without being gripped by the detent mechanism, and detent mechanism 34 is configured to engage and releasably grip engagement segment 32C as the engagement segment passes within the detent mechanism. As shown in FIG. 7, detent mechanism 34 may include a hollow sleeve 36 defining a passage 38 through which connection rod 32 is slidably received, and one or more spring-biased ball plungers 40 biased to project radially into passage 38 through respective holes 42 in the wall of sleeve 36. Each ball plunger 40 is urged to project into passage 38 by a corresponding spring 44. Engagement segment 32C of connection rod 32 is of enlarged diameter relative to first and second slide segments 32A, 32B and includes at least one recess 37 for receiving a protruding ball plunger 40 upon alignment with the ball plunger. Thus, detent mechanism 34 is biased for releasable engagement with engagement segment 32C of connection rod 32 to releasably couple head portion 18 and the tail portion 20 together.

Apparatus 10 may further comprise a forward limit stop 46 preventing tail portion 20 from traveling forward relative to the main portion beyond the forward retracted position and a rearward limit stop 48 preventing tail portion 20 from traveling rearward relative to the main portion beyond the rearward extended position. In the depicted embodiment, a flange projecting laterally from each side rail 20A, 20B of tail portion 20 acts as forward limit stop 46. Forward limit stop 46 abuts with a corresponding side rail 20A, 20B when tail portion 20 reaches its forward retracted position, thereby limiting further insertion of side rails 20A, 20B into the hollow longitudinal side rails 16A, 16B of main portion 16. Rearward limit stop 48 may be mounted on a shaft 50 attached to a cross member 51 of tail portion 20 and slidably mated with a sleeve 52 fixed to a cross-member 54 of main portion 16. Rearward limit stop 48 abuts with sleeve 52 when tail portion 20 reaches its rearward extended position. As a result, a longitudinal displacement distance of tail portion 20 between its rearward extended position and its forward retracted position is limited to a predefined distance.

The longitudinal displacement distance of head portion 18 between its rearward retracted position and its forward extended position may be defined by the stroke length of hoist actuator 28. In the embodiment described herein, the longitudinal displacement distance of head portion 18 between its rearward retracted position and its forward extended position is greater than the longitudinal displacement distance of tail portion 20 between its rearward extended position and forward retracted position. In other words, head portion 18 has a greater longitudinal travel range than tail portion 20.

Linkage 30 may be configured to couple head portion 18 and tail portion 20 together for displacement in unison under the power of hoist actuator 28 when tail portion 20 is between the limit stops 46, 48, and to decouple head portion 18 from tail portion 20 for independent displacement of head portion 18 relative to main portion 16 when tail portion is at one of the limit stops 46, 48. Thus, when tail portion 20 is stopped at forward limit stop 46, head portion 18 can continue to move forward, and when tail portion 20 is stopped at rearward limit stop 48, head portion 18 can continue to move rearward.

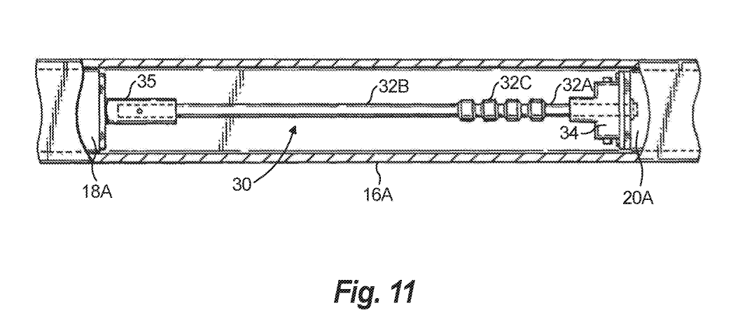

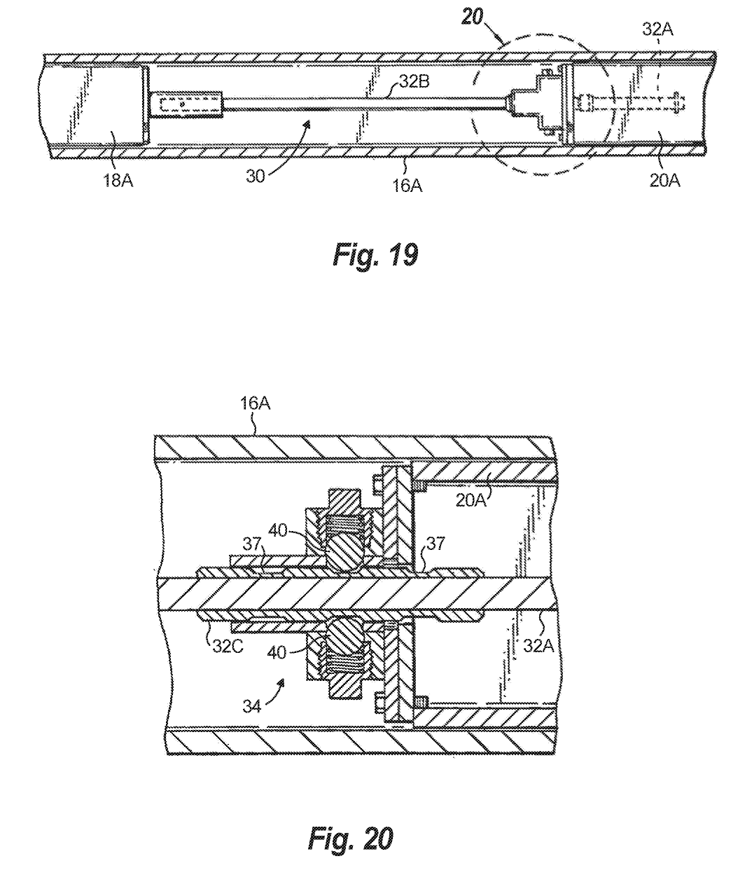

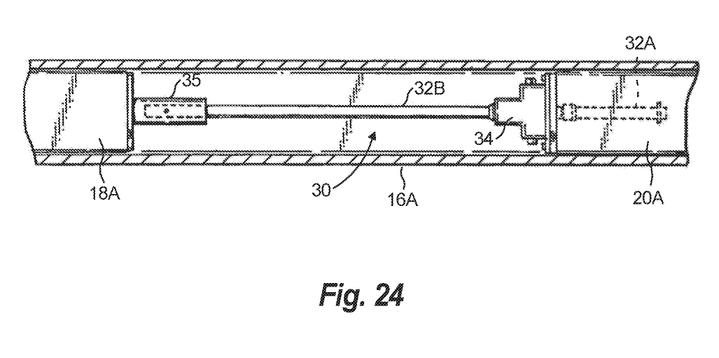

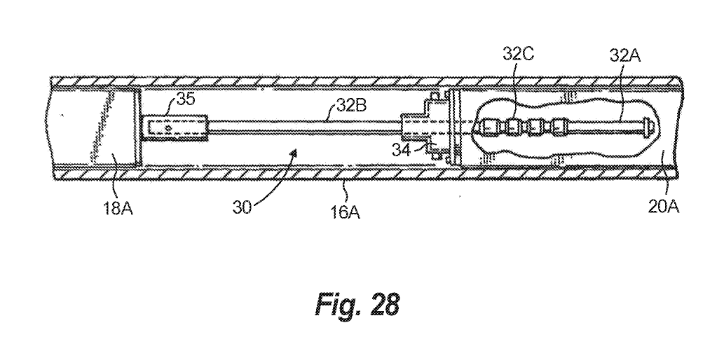

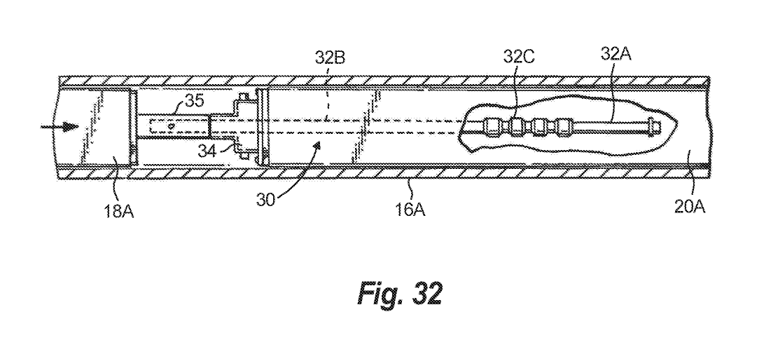

FIGS. 8-32 illustrate displacement of head portion 18 from its forward extended position to its rearward retracted position by hoist actuator 28, and the resulting displacement behavior of tail portion 20 due to linkage 30. The displacement of head portion 18 and tail portion 20 is shown and described in the context of a process by which container C is unloaded from vehicle V.

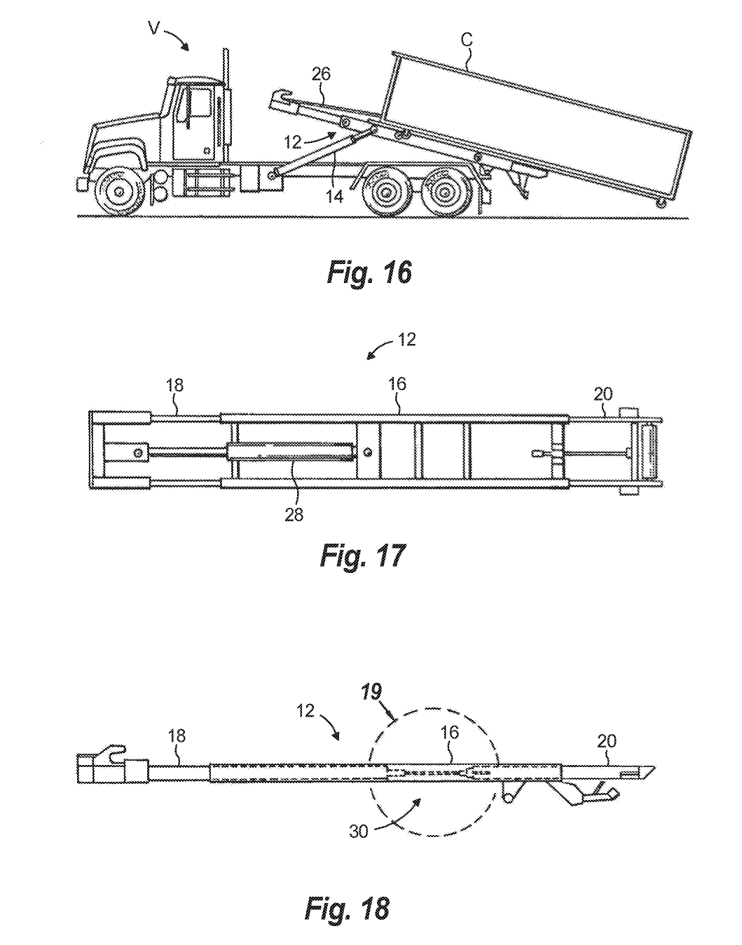

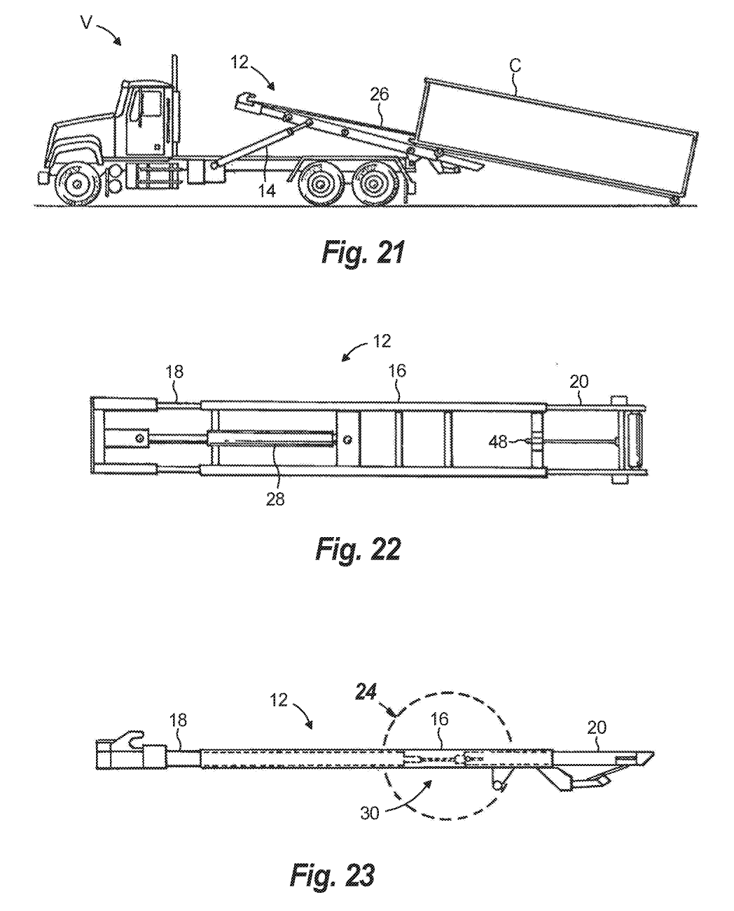

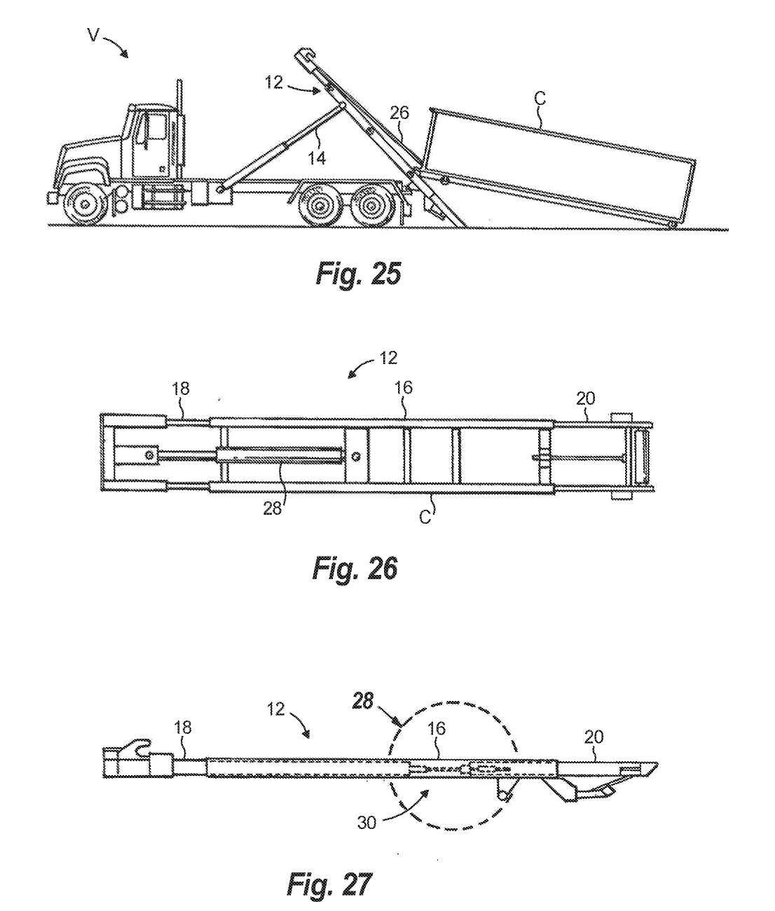

In initial FIGS. 8-11 depicting container C fully loaded on vehicle V, hoist actuator 28 is fully extended such that head portion 18 is in its forward extended position, and tail portion 20 is in its forward retracted position. As hoist actuator 28 starts to retract as shown in FIGS. 12-15, head portion 18 begins to move rearward relative to main portion 16 and first slide segment 32A of connection rod 32 slides through detent mechanism 34; tail portion 20 remains in its forward retracted position during this initial rearward movement of head portion 18. Once engagement segment 32C reaches ball plungers 40, the ball plungers are urged outward against the bias of springs 44 until a recess 37 of engagement segment 32C moves into alignment with ball plungers 40 and the ball plungers 40 are forced inward by springs 44 into engagement with recess 37. When this occurs, tail portion 20 becomes coupled to head portion 18, such that further retraction of hoist actuator 28 causes both head portion 18 and tail portion 20 to move rearward in unison as depicted in FIGS. 16-20. Continued retraction of hoist actuator 28 eventually causes tail portion 20 to reach its rearward extended position, at which point rearward limit stop 48 abuts with sleeve 52 to prevent further rearward displacement of tail portion 20. This position is shown in FIGS. 21-24. As hoist actuator 28 retracts further as shown in FIGS. 25-28, rearward displacement of head portion 18 pushes engagement segment 32C through detent mechanism 34, and second slide segment 32B aligns with detent mechanism 34. Finally, as shown in FIGS. 29-32, hoist actuator 28 is fully retracted and head portion 18 reaches its rearward retracted position while tail portion 20 remains in its rearward extended position.

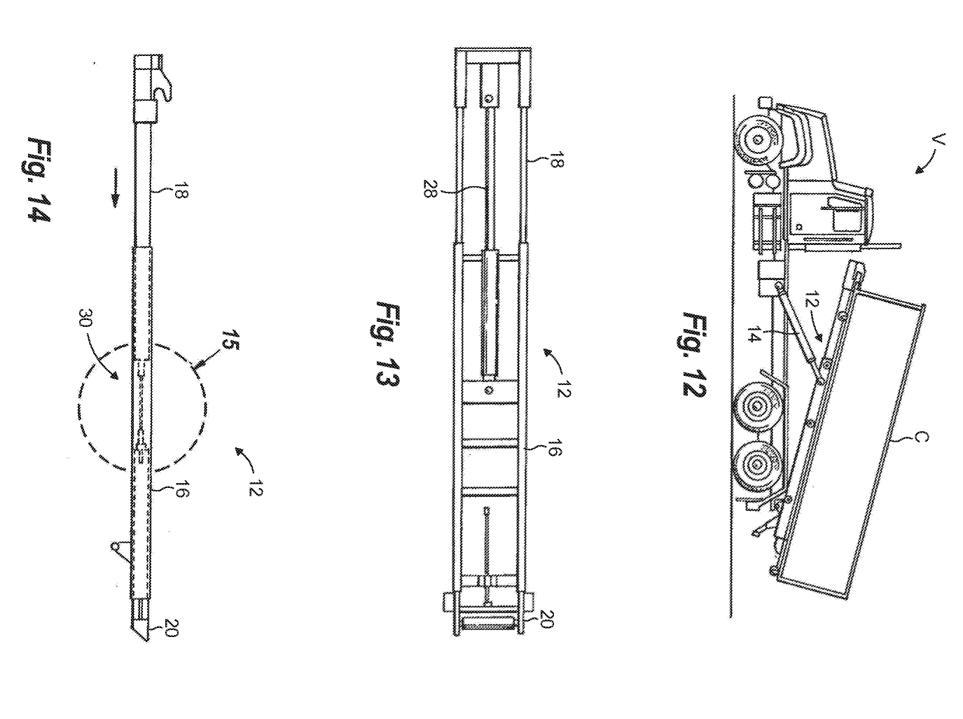

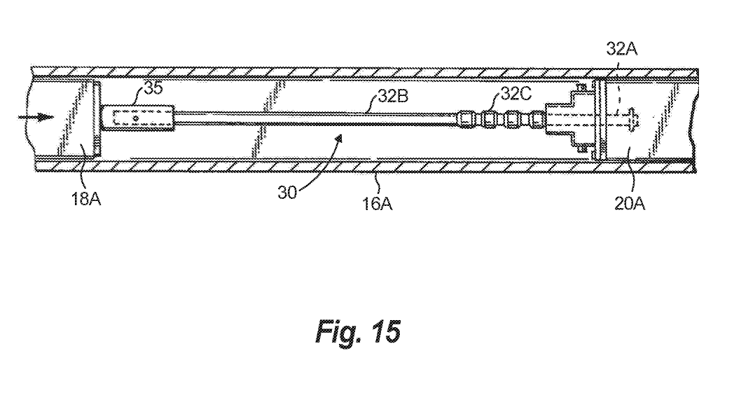

As may be understood, displacement of head portion 18 from its rearward retracted position to its forward extended position by hoist actuator 28, and the resulting displacement behavior of tail portion 20 due to linkage 30, can be understood with reference to FIGS. 8-32 taken in stepwise reverse order. Hoist actuator 28 starts in a fully retracted condition in FIGS. 29-32 such that head portion 18 is in its rearward retracted position and tail portion 20 is in its rearward extended position. As hoist actuator 28 starts to extend in FIGS. 25-28, head portion 18 begins to move forward relative to main portion 16 and second slide segment 32B of connection rod 32 slides through detent mechanism 34 while tail portion 20 remains stationary in its rearward extended position during this initial forward movement of head portion 18. Once engagement segment 32C reaches ball plungers 40, the ball plungers are urged outward against the bias of springs 44 until a recess 37 of engagement segment 32C moves into alignment with ball plungers 40 and the ball plungers 40 are forced inward by springs 44 into engagement with recess 37. When this occurs, tail portion 20 becomes coupled to head portion 18 as shown in FIGS. 21-24. Continued extension of hoist actuator 28 causes head portion 18 and tail portion 20 to move together in the forward direction according to FIGS. 16-20. Continued extension of hoist actuator 28 eventually causes tail portion 20 to reach its forward retracted position, shown in FIGS. 12-15, at which point forward limit stops 46 abut with longitudinal side rails 16A, 16B of main portion 16 to prevent further forward displacement of tail portion 20. As hoist actuator 28 extends further, forward displacement of head portion 18 pulls engagement segment 32C through detent mechanism 34 as shown in FIG. 15, and first slide segment 32A aligns with detent mechanism 34. Finally, as shown in FIGS. 8-11, hoist actuator 28 is fully extended and head portion 18 reaches its forward extended position while tail portion 20 remains in its forward retracted position.

Operation of apparatus 10 to unload a container C from vehicle V will now be described with reference to FIGS. 8, 12, 16, 21, 25, and 29. As shown in FIG. 8, vehicle V is parked with container C fully loaded on vehicle V. Lift actuators 14 are fully retracted such that top frame 12 is lowered to its horizontal home position used when transporting container C. Cable end 26B is drawn completely forward and is coupled to the front end of container C.

Next, lift actuators 14 are operated to tilt top frame 12 as shown in FIG. 12. Hoist actuator 28 is operated to retract slightly such that head portion 18 moves away slightly from its forward extended position, and tail portion 20 remains at its forward retracted position. Cable end 26B moves rearward a short distance.

Next, in FIG. 16, hoist actuator 28 is operated to retract further, causing head portion 18 to retract further and allowing cable end 26B to be pulled rearward by the weight of container C as container C rolls down the inclined top frame 12. During this stage, tail portion 20 starts to extend in the rearward direction by virtue of its linkage with head portion 18.

In FIG. 21, hoist actuator is retracted further until the rear end of container C makes contact with the ground. At this stage, tail portion 20 has reached its rearward extended position limited by rearward limit stop 48.

Next, in FIG. 25, lift actuators 14 are extended to increase the incline of top frame 12 such that tail portion 20 makes contact with the ground behind vehicle V. causing cable end 26B retracted e

Finally, in FIG. 29, hoist actuator 28 is retracted fully to allow container C to roll off top frame 12 and onto the ground.

As may be understood, a reverse process may be followed for loading container C onto vehicle V. Vehicle V is parked with its rear end adjacent to a front end of container C, lift actuators 14 are extended to rearwardly incline top frame 12, and the free end 26B of cable 26 is coupled to a front coupling element provided on container C. At this stage, hoist actuator 28 is fully retracted such that head portion 18 is in its rearward retracted position and tail portion 20 is in its rearward extended position touching the ground.

Hoist actuator 28 begins to extend while top frame 12 is fully inclined, thereby starting to displace head portion 18 forward and draw cable end 26B toward the front of top frame 12. As a result, the front end of container C is lifted onto top frame 12. At this stage, tail portion 20 is uncoupled from head portion 18 and remains in contact with the ground.

Next, lift actuators 14 are retracted enough to lower top frame 12 to a shallower incline substantially even with an incline of container C, whereby the rear end of tail portion 20 is lifted away from the ground. During this stage, hoist actuator 28 is kept at a constant length.

Hoist actuator 28 continues to extend and displace head portion 18 forward, thereby pulling cable end 26B and container C closer to the front of top frame 12. As this occurs, tail portion 20 becomes coupled to head portion 18 and moves forward with head portion 18. Meanwhile, lift actuators 14 are kept at a constant length.

Next, hoist actuator 28 is extended almost fully. Head portion 18 is close to its forward extended position, and tail portion 20 has reached its forward retracted position. Cable end 26B is almost drawn completely forward to move the front end of container C to the front of top frame 12. Lift actuators 14 are kept at a constant length to maintain the same incline of top frame 12 relative to vehicle V.

Finally, hoist actuator 28 is fully extended to bring head portion 18 to its forward extended position such that cable end 26B and container C are pulled to the front of top frame 12, and lift actuators 14 are fully retracted to bring top frame 12 down to its horizontal home position for transport of container C.

It will be appreciated that hoist actuator 28 drives the displacement of both head portion 18 and tail portion 20 during loading and unloading by virtue of linkage 30. Consequently, the present invention avoids the need for an additional actuator dedicated solely to moving tail portion 20 and related hydraulic and electronic circuitry and controls associated therewith.

While the invention has been described in connection with an exemplary embodiment, the detailed description is not intended to limit the scope of the invention to the particular forms set forth. The invention is intended to cover such alternatives, modifications and equivalents of the described embodiment as may be included within the scope of the invention.

What is claimed is:

1. A container hoist apparatus for a roll-off vehicle, the apparatus comprising:
i) a top frame including a main portion, a head portion movably connected to the main portion for longitudinally directed displacement relative to the main portion between a rearward retracted position and forward extended position, and a tail portion movably connected to the main portion for longitudinally directed displacement relative to the main portion between a rearward extended position and forward retracted position;
ii) a plurality of sheaves including a rear sheave mounted to the main portion and a front sheave mounted to the head portion;
iii) a cable having a fixed end coupled to the head portion and a free end configured for coupling to a container, the cable extending from the fixed end to the free end by way of the plurality of sheaves;
iv) a hoist actuator operable to longitudinally displace the head portion relative to the main portion between the rearward retracted position and the forward extended position; and
v) a linkage connecting the tail portion to the head portion;
wherein displacement of the head portion by the hoist actuator relative to the main portion causes displacement of the tail portion relative to the main portion.

2. The apparatus according to claim 1, wherein displacement of the head portion by the hoist actuator from the rearward retracted position to the forward extended position causes displacement of the tail portion from the rearward extended position to the forward retracted position, and displacement of the head portion by the hoist actuator from the forward extended position to the rearward retracted position causes displacement of the tail portion from the forward retracted position to the rearward extended position.

3. The apparatus according to claim 2, wherein a longitudinal displacement distance of the head portion between the rearward retracted position and the forward extended position is greater than a longitudinal displacement distance of the tail portion between the rearward extended position and the forward retracted position.

4. The apparatus according to claim 3, further comprising a forward limit stop preventing the tail portion from traveling forward relative to the main portion beyond the forward retracted position and a rearward limit stop preventing the tail portion from traveling rearward relative to the main portion beyond the rearward extended position, and wherein the linkage is configured to couple the head portion and the tail portion together for displacement in unison when the tail portion is between the forward and rearward limit stops and configured to decouple the head portion from the tail portion for independent displacement of the head portion relative to the main portion when the tail portion is at one of the forward and rearward limit stops.

5. The apparatus according to claim 3, wherein the linkage includes:
a connection rod fixed to one of the head portion and the tail portion, the connection rod having an engagement segment; and
a detent mechanism fixed to the other of the head portion and the tail portion, wherein the connection rod is slidably received by the detent mechanism;
wherein the detent mechanism is biased for releasable engagement with the engagement segment of the connection rod to releasably couple the head portion and the tail portion together.

6. The apparatus according to claim 5, wherein the engagement segment of the connection rod includes at least one recess, and the detent mechanism includes at least one ball plunger spring-biased for receipt by the at least one recess.

7. The apparatus according to claim 5, wherein the connection rod includes a first slide segment and a second slide segment, and the engagement segment is between the first and second slide segments.

8. The apparatus according to claim 1, wherein the top frame is mounted on the vehicle to pivot about a transverse hinge axis relative to the vehicle, the top frame having a horizontal home position relative to the vehicle, and the apparatus further comprises at least one lift actuator operable to rearwardly incline the top frame relative to the vehicle by pivoting the top frame about the hinge axis away from the horizontal home position.
